(19) United States
(12) Patent Application Publication
(10) Pub. No.: US 2026/0269970 A1
(43) Pub. Date: Sep. 10, 2026

(54) OPERATION OF A WAVELENGTH DIVISION MULTIPLEXING COMMUNICATION SYSTEM

(71) Applicant: Telefonaktiebolaget LM Ericsson (publ), Stockholm (SE)

(72) Inventors: Roberto MAGRI, Genova (IT); Giorgio ANDREOLI ARMANNI, Genova (IT); Daniel BEDINI, Genova (IT); Matteo AGOSTINI, Genova (IT); Alfredo ZAMORA, Genova (IT); Marco DISTEFANO, Genova (IT)

(21) Appl. No.: 19/165,344

(22) PCT Filed: Mar. 20, 2023
(86) PCT No.: PCT/EP2023/057068

§ 371 Date: Sep. 15, 2025

(51) Int. Cl. H04J 14/02; H04B 10/25

(52) U.S. Cl. CPC H04J 14/02; H04B 10/25

(57) ABSTRACT

In an embodiment, a method of tagging an optical signal generated by an optical source of a wavelength division multiplexing, WDM, communication system is described. The method comprises generating a first tag by encoding the optical signal with first information. The optical source is in a set of optical sources of the WDM communication system. Each of the set of optical sources is instructed to generate the first tag at a common time.

### TECHNICAL FIELD

The present disclosure relates to operation of a wavelength division multiplexing (WDM) communication system, and in particular to: a WDM communication system, a method, machine-readable medium and controller for tagging an optical signal; a method, machine-readable medium and controller for controlling the WDM communication system; and a method, machine-readable medium and apparatus for evaluating the WDM communication system.

### BACKGROUND

Serviceability of equipment and installations for communication networks is of increasing importance to network operators. Costs relating to installation, commissioning, integration and troubleshooting are a significant part of overall operational expenditure. Simplifying the installation and troubleshooting phases of equipment deployment is therefore highly desirable.

With respect to optical fiber installations, automation of many aspects of installation, integration and configuration has been achieved, but some activities still require manual operations, making them time consuming and error prone. Fiber cabling is a manual operation that is usually performed by following connection matrices printed on paper. The printed matrices provide source and destination ports for equipment, optical distribution frames, etc. Following fiber and patch-cords paths can be highly challenging, and identifying and correcting fiber misconnection is a time consuming and difficult process. Cabling is therefore one of the major causes of integration issues for communication networks.

A signal may be sent via an optical fiber. The signal may be detected at an output of the optical fiber. Connectivity information may be determined from the detected signal (or lack of such a signal) to assist an engineer with service tasks such as installation, commissioning and maintenance of the optical fiber. However, such connectivity information may be of limited use for certain service tasks.

### SUMMARY

Certain embodiments described herein may be used to assist with service tasks associated with a wavelength division multiplexing (WDM) communication system while reducing or obviating problems with existing solutions.

According to a first aspect of the present disclosure, there is provided a method of tagging an optical signal generated by an optical source of a wavelength division multiplexing, WDM, communication system. The method comprises generating a first tag by encoding the optical signal with first information. The optical source is in a set of optical sources of the WDM communication system. Each of the set of optical sources is instructed to generate the first tag at a common time.

According to a second aspect of the present disclosure, there is provided a method of controlling a wavelength division multiplexing, WDM, communication system. The method comprises, in response to an instruction, causing a set of optical sources of the WDM communication system to generate a first tag. The first tag is generated by encoding an optical signal generated by the optical source with first information. Each of the set of optical sources is instructed to generate the first tag at a common time.

According to a third aspect of the present disclosure, there is provided a computer-implemented method of evaluating a wavelength division multiplexing, WDM, communication system. The method comprises receiving a waveform representative of one or more optical signals received at a detector. The waveform is indicative of a first tag generated by one or more optical sources of a set of optical sources of the WDM communication system. The first tag is generated by encoding the optical signal generated by the optical source with first information. Each of the set of optical sources is instructed to generate the first tag at a common time. The method further comprises determining a first characteristic of the WDM communication system based on the first tag derived from the waveform.

According to a fourth aspect of the present disclosure, there is provided an optical source controller for controlling tagging of an optical signal generated by an optical source of a wavelength division multiplexing, WDM, communication system. The optical source controller is configured to instruct the optical source to implement the method of the first aspect.

According to a fifth aspect of the present disclosure, there is provided a wavelength division multiplexing, WDM, communication system controller for controlling a WDM communication system. The WDM communication system controller is configured to instruct the WDM communication system to implement the method of the second aspect.

According to a sixth aspect of the present disclosure, there is provided apparatus for evaluating a wavelength division multiplexing, WDM, communication system. The apparatus is configured to implement the computer-implemented method of the third aspect.

According to a seventh aspect of the present disclosure, there is provided a wavelength division multiplexing, WDM, communication system. The WDM communication system comprises: a set of optical sources; an optical source controller according to the first aspect; and a WDM communication system controller according to the second aspect.

According to an eighth aspect of the present disclosure, there is provided a machine-readable medium storing instructions which, when executed by a processor, instruct the processor to implement the method of any of the first, second and third aspects.

Certain embodiments of the present disclosure may provide one or more of the following technical benefits. For example, certain embodiments may be used in the scenario where an optical signal is wavelength division multiplexed with other optical signals to form a WDM signal to be carried by an optical fiber. By tagging the optical signals in accordance with certain embodiments, information such as connectivity information may be determined from the WDM signal (or lack of such a signal). Further information may be derived from the tag such as concerning the identity, location, status, etc., of a component in the WDM communication system. Further, certain embodiments may enable such information to be determined at different locations in a WDM communication system, including where the WDM signal may be detected or where an optical signal (that has been demultiplexed from the WDM signal) may be detected, thereby providing additional flexibility and control for service tasks. Certain embodiments may allow information to be extracted from the WDM signal where such information may otherwise be scrambled due to the multiplexing. Certain embodiments may provide a simple to use tool (which may be controlled by user equipment such as a smartphone) to assist an engineer with servicing complex optical fiber arrangements without having to rely solely on connection matrices printed on paper.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 is a schematic diagram illustrating components of a WDM communication system that implement certain embodiments;

FIG. 2 is a flowchart of a method of tagging an optical signal according to an embodiment;

FIG. 3 is a flowchart of a method of tagging an optical signal according to certain embodiments;

FIG. 4 is a schematic diagram illustrating a frame of an optical signal according to an embodiment;

FIG. 5 is a schematic diagram illustrating frame alignment between optical signals of a set of optical signals according to an embodiment;

FIG. 6 is a flowchart of a method of controlling a WDM communication system according to an embodiment;

FIG. 7 is a flowchart of a method of controlling a WDM communication system according to certain embodiments;

FIG. 8 is a flowchart of a method of controlling a WDM communication system according to an embodiment;

FIG. 9 is a flowchart of a method of evaluating a WDM communication system according to an embodiment;

FIG. 10 is a flowchart of a method of evaluating a WDM communication system according to certain embodiments; and

FIG. 11 is a schematic diagram illustrating a processor and a machine-readable medium for implementing certain embodiments.

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

As already discussed, it is possible to use a signal (or lack of such a signal) sent via an optical fiber to determine connectivity information for assisting an engineer with service tasks such as installation, commissioning and maintenance of the optical fiber. However, such connectivity information may be of limited use for certain service tasks. For example, such a modulated signal may be applied to a single optical signal to be sent via the optical fiber to avoid scrambling the information in the modulated signal. Combining multiple optical signals, each carrying signal specific information, in a multiplexed optical fiber may hinder or prevent the extraction of valid information.

Hence, there is a need to assist with tasks associated with servicing a WDM communication system while reducing or obviating problems with existing solutions.

Certain embodiments described herein may offer a solution to one or more of the problems highlighted herein.

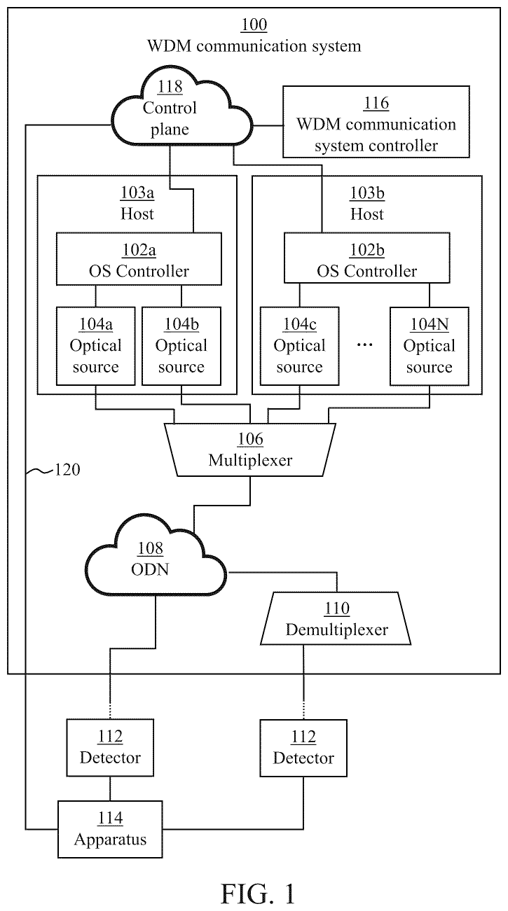

FIG. 1 is a schematic diagram illustrating components of a WDM communication system 100 that implement certain embodiments as described herein.

The WDM communication system 100 comprises an optical source (OS) controller 102a of a first host equipment 103a and an optional additional optical source (OS) controller 102b of an optional second host equipment 103b. The WDM communication system 100 may comprise one or more host equipment 103. The WDM communication system 100 may comprise a single optical source controller 102a or multiple (e.g., two or more) optical source controllers 102a, 102b (collectively 102) distributed among the one or more host equipment 103. The WDM communication system 100 comprises a set of optical sources 104a, 104b, 104c to 104N (collectively, 104) such as laser diodes. Each optical source 104 is configured to produce an optical signal. The set of optical sources 104 may be included as part of one or more of the host equipment 103a, 103b (collectively 103). For example, as shown by FIG. 1, a first subset of the set of optical sources 104 (i.e., optical sources 104a, 104b) are part of the first host equipment 103a. A second subset of the set of optical sources 104 (i.e., optical sources 104c, . . . , 104N) are part of the second host equipment 103b. Thus, each host equipment 103 may comprise an optical source controller 102 and one or more optical sources 104 of the set of optical sources 104. Each optical source 104 may be considered to be a (transmitting) port of its respective host equipment 103 of the WDM communication system 100. The optical source controller 102 controls the operation of the subset or set of optical sources 104 of the host equipment 103. For example, the optical source controller 102 may control the generation and modulation of a set of optical signals by the set of optical sources 104 as part of a service mode or a data carrying mode of the WDM communication system 100. A data plane of the WDM communication system may be used to carry data (e.g., customer data) in the data-carrying mode. The data plane may be unused in the service mode. WDM communication includes related types of WDM communication such as Dense WDM (DWDM) communication.

The WDM communication system 100 may implement control instructions of a control plane of the WDM communication system 100 in the service mode or data carrying mode. The service mode may be considered to be a “connectivity assist mode” or “Sign of Light” state of the WDM communication system 100. The service mode may therefore be implemented by a service engineer to enable the service engineer to perform service tasks, which may include installation, commissioning, integration, maintenance and troubleshooting of the WDM communication system 100.

Each one of the set of optical signals has a different wavelength to allow one or more of the set of optical signals to be multiplexed, by a multiplexer 106, into a WDM signal. An optical signal generated by an optical source 104 may comprise a modulated carrier signal which, when multiplexed with other modulated carrier signals generated by one or more other optical sources 104, forms a WDM signal. The set of optical sources 104 is configured to produce the set of optical signals (i.e., one optical signal is produced per optical source 104). An optical source 104 of the set of optical sources 104 is dedicated to producing a different (i.e., unique) one of the set of optical signals that are multiplexed into the WDM signal. The optical source controller 102 is configured to control the generation and modulation of each of the optical signals in either (or both) the service mode or data-carrying mode by controlling the operation of the subset or set of optical sources 104 (i.e., the subset of optical sources 104 controlled by the optical source controller 102). Hence, the optical source controller 102 may instruct one or more of the set of optical sources 104 to generate and modulate the corresponding optical signal(s) on demand according to an electronic control signal sent from the optical source controller 102 to one or more of the set of optical sources 104. For example, such an electronic control signal may modulate or cause the modulation of the optical output by one or more of the set of the optical sources 104 to thereby generate the optical signal(s).

As already explained, the set of optical sources 104 are hosted by one or more host equipment 103. As shown, each host equipment 103 includes an optical source controller 102 as part of the host equipment 103 itself. Thus, the optical source controller 102 and the respective subset of optical sources 104 are all part of the same host equipment 103, which may be in the form of a hardware module. In other cases, the optical source controller 102 for a subset of optical sources 104 may be in a separate host equipment 103 or in separate equipment to the host equipment 103 that hosts the subset of optical sources 104. In some cases, a subset (comprising one or more optical sources 104) of the set of optical sources 104 may be in one host equipment 103 and another subset of the set of optical sources 104 may be in another host equipment 103 (as depicted by FIG. 1) so that the set of optical signals forming the multiplexed WDM signal are derived from two or more host equipment 103 housing the set of optical sources 104. In some cases, every one of the set of optical sources 104 may be housed in the same host equipment 103.

After one or more of the optical signals has been multiplexed, the WDM signal is transmitted via an optical distribution network (ODN) 108 such as a passive ODN. A service engineer may need to perform certain service tasks at various physical locations in the WDM communication system 100. In some cases, such a location may be the output of an optical fiber or another component carrying the WDM signal. In some cases, such a location may be the output of an optical fiber or another component carrying a single optical signal (e.g., after the WDM signal has been demultiplexed by a demultiplexer 110). Depending on the service task, a detector 112 (such as a smartphone camera or other form of photodetector with the capability to detect the wavelength of the optical signal with a fast enough detection response time according to the modulation rate of the signal) may be positioned to detect the signal (i.e., the optical signal or WDM signal, depending on location of interest) or lack of such a signal at the location. In accordance with embodiments described herein, the signal may be modulated in a such a way to assist with the service task such that certain information can be extracted from the signal by an apparatus 114 communicatively coupled to the detector 112. The apparatus 114 may comprise a user equipment such as a smartphone, handheld computer or other electronic processing apparatus (which could also be remote to the detector 112) configured to process the detected signal to extract the information therefrom. In some cases, the detector 112 may be part of the apparatus 114. For example, the detector 112 may comprise a camera of the apparatus 114.

The optical source controller 102 of the host equipment 103 is communicatively coupled to a WDM communication system controller 116 of the WDM communication system 100 via a control plane 118 of the WDM communication system 100. The control plane 118 allows control instructions (e.g., provided by the apparatus 114 and/or the WDM communication system controller 116) to be routed to/from the optical source controller 102 and/or the WDM communication system controller 116. For example, the control instructions (e.g., from the apparatus 114 or the WDM communication system controller 114) may cause an optical source controller 102 to operate optical sources 104 under its control to perform an operation such as implementing an embodiment as described herein. In another example, the control instructions (e.g., from the apparatus 114) may cause the WDM communication system controller 116 to perform an operation such as implementing an embodiment as described herein. Thus, the apparatus 114 is communicatively coupled to the WDM communication system controller 116 and/or the optical source controller 102 via the control plane 118. The apparatus 114 is configured to send control instructions to the control plane 118 (for receipt by the WDM communication system controller 116 or an optical source controller 102) via a communication link 120 between the apparatus 114 and the control plane 118. The control plane 118 may comprise compute infrastructure (not shown, but could be cloud computing-based or server-based) to allow receiving, processing and/or forwarding of control instructions between two or more of the apparatus 114, WDM communication system controller 116 and the optical source controller 102. The communication link 120 may comprise a wired or wireless communication link between the apparatus 114 and the WDM communication system 100 to allow exchange of communications such as control instructions.

In some cases, the control instructions provided by the apparatus 114 may instruct the WDM communication system controller 116 to perform an operation such as implementing an embodiment as described herein. In some cases, the control instructions provided by the apparatus 114 may directly instruct optical source controller(s) 102 to perform an operation such as implementing an embodiment as described herein.

In some cases, the WDM communication system controller 116 is configured to control the optical source controller 102 via the control plane 118 e.g., by sending control instructions to the optical source controller 102 where such control instructions may cause the optical source controller 102 to switch between the service mode or data-carrying mode and implement operations as part of such modes.

Thus, a service engineer may use the apparatus 114 to instruct the WDM communication system 100 to operate in such a way to allow the service engineer to carry out a service task.

A service task may involve causing one or more of the set of optical sources 104 to produce an optical signal with an optical “tag” that can be used as part of the service task. Such a tag may be indicative of certain information such as an identity of the optical source 104 that produced the tag (or optical signal) or other information that may be of interest to the service engineer. The tag or lack of the tag may be detectable by the detector 112 detecting an optical signal (or lack of optical signal). The presence of the tag in an optical signal detected at an expected physical location (such as an output of an optical fiber or other component) in the WDM communication system 100 may indicate that at least part of the WDM communication system 100 is set up correctly and functioning correctly. However, the lack of the tag or the wrong (unexpected) tag in an optical signal detected at the physical location may indicate that at least part of the WDM communication system 100 is set up incorrectly (such as an incorrectly installed optical fiber connection). A correct tag in the optical signal detected at a particular physical location may indicate correct installation or configuration of the optical source 104 within the WDM communication system 100. A wrong or unexpected tag in the optical signal detected at the physical location may indicate incorrect installation or configuration of the optical source 104 (such as an optical fiber not connected to the correct/expected port of the host equipment 103 or other equipment such as a multiplexer or demultiplexer). The tag may indicate information such as an identity of the optical source 104 that generated the optical signal. Since the identity of the optical source 104 can be determined based on the tag, if necessary, remedial action may be taken by the service engineer to correct an incorrectly installed component of the WDM communication system 100. Such information may be invaluable to the service engineer and may speed up completion of the service task.

In an example scenario, a single optical fiber may carry multiple aggregated (i.e., multiplexed) optical signals. In some cases, one or more optical signals are generated by a set of optical sources 104, each operating at a different wavelength of the set of optical signals. The one or more optical signals may be multiplexed together and directed into the optical fiber. The multiplexing may be selective using filters or non-selective using couplers. In either case, the resulting WDM signal is carried by the optical fiber.

It may be useful as part of the service task to obtain information related to either or both the individual optical signals (i.e., after demultiplexing) and the aggregated (WDM) signal. For example, the information associated with the aggregated WDM signal may be indicative of the location or identity of equipment where the optical signals were generated, the owner of the hardware, the domain, or the identity of the optical fiber, etc. In some examples, the information associated with the aggregated WDM signal indicates an identity or information common to the set of optical signals forming or carrying the aggregated WDM signal, e.g., a common optical source controller 102 or common part of the ODN 108. In an example scenario, there may be multiple host equipment 103 with multiple ports. A port may be a transmitting port as described previously, or a receiving port such as in a passive component such as a multiplexer 106 or demultiplexer 110. In some examples, a port may be considered as a transmitter or receiver, or a transceiver. A port may provide an optical interface for an optical signal that may be multiplexed with other optical signals, transmitted as a WDM signal on a single fiber, and subsequently demultiplexed. The user may be able, by using the apparatus 114, to obtain so-called “aggregate information” when detecting the output of an optical fiber carrying multiplexed signals (e.g., a WDM line fiber) or detailed port information when detecting the output of a terminal fiber carrying a single optical signal (e.g., a client fiber carrying a single optical signal). As used herein, aggregate information refers to information carried by the aggregated set of optical signals and is the same information across each of the set of optical signals, or a subset of the optical signals. Aggregate information may be indicative of a parameter (such as location, identity or status of equipment) of the WDM communication system 100 where such a parameter may be useful for the service task.

Embodiments described herein refer to operating the WDM communication system 100 in such a way to control and use tagging of one or more optical signals to facilitate a range of service tasks.

In some embodiments, the optical source controller 102 is used to control tagging of an optical signal generated by an optical source 104a of the WDM communication system 100. The optical source controller 102 is configured to instruct the optical source 104 (i.e., the optical source 104 dedicated to generating a specified optical signal at a unique wavelength of the set of optical signals) to implement the method of certain embodiments described herein based on tagging the optical signal generated by the optical source 104a.

As noted above, the optical source controller 102 may send an electronic control signal to the optical source 104a to modulate or cause the modulation of the optical signal generated by the optical source 104a. Such an electronic control signal may instruct the optical source 104a to implement certain methods described herein. In some cases, the electronic control signal may be the power input to the optical source 104 to drive generation of the optical signal. Modulation of the electronic control signal may therefore have the effect of modulating the power input to the optical source 104 and thereby modulate the optical signal generated by the optical source 104.

The electronic control signal may be generated by the optical source controller 102. For example, the optical source controller 102 may comprise a processor and a memory (not shown but see below) storing instructions readable and executable by the processor to generate the electronic control signal so as to instruct or cause the optical source 104a to implement the methods of certain embodiments described herein. Such methods may or may not be considered to be computer-implemented since these methods generally refer to operation of the optical source 104a itself.

In some embodiments, the WDM communication system controller 116 is used to control the WDM communication system 100. The WDM communication system controller 116 is configured to instruct the WDM communication system 100 to implement certain methods described herein based on instructing one or more of the optical sources to tag one or more optical signals.

The instructing of the set of optical sources may be processed by the WDM communication system controller 116, for example, upon request by the service engineer. The service engineer may (manually) make the request for the WDM communication system controller 116 to instruct one or more optical sources to tag one or more optical signals by inputting an instruction via a user interface (not shown) of the apparatus 114 (such as a smartphone or other user equipment) to cause the apparatus 114 to send a control instruction to the WDM communication system controller 116 and/or the optical source controller 102 via the communication link 120. In another scenario, the apparatus 114 may automatically instruct the sending of the control instruction e.g., triggered by a fault condition such as data transport failure. The control instruction may instruct the WDM communication system controller 116 to implement its functionality as described herein (such as controlling the WDM communication system 100). For example, the WDM communication system controller 116 may comprise a processor and a memory (not shown but see below) storing instructions readable and executable by the processor to instruct or cause the optical source controller 102 to implement the methods of certain embodiments described herein e.g., in response to receipt of the control instruction from the apparatus 114. Such methods may or may not be considered to be computer-implemented since these methods generally refer to the act of signaling.

In some embodiments, the apparatus 114 is used to evaluate the WDM communication system 100. As noted above, the WDM communication system 100 comprises the set of optical sources 104 configured to generate the set of optical signals. Each optical source 104 is configured to a generate a different one of the set of optical signals. The apparatus 114 is configured to implement the computer-implemented method of certain embodiments described herein based on analyzing and using an electronic signal generated by the detector 112 as a result of detecting the signal (i.e., one or more of the set of optical signals) at a physical location of interest in the WDM communication system 100. The apparatus 114 may comprise a processor and a memory (not shown but see below) storing instructions readable and executable by the processor to implement such computer-implemented methods. In some cases, the apparatus 114 may be or be part of a user equipment such as a smart phone or other user device. In some cases, the apparatus 114 may be or be part of a remote processing apparatus such as a server, cloud infrastructure, etc., providing the electronic signal generated by the detector 112 is able to be sent to such a remote processing apparatus.

Embodiments in and relating to the WDM communication system 100 are now described.

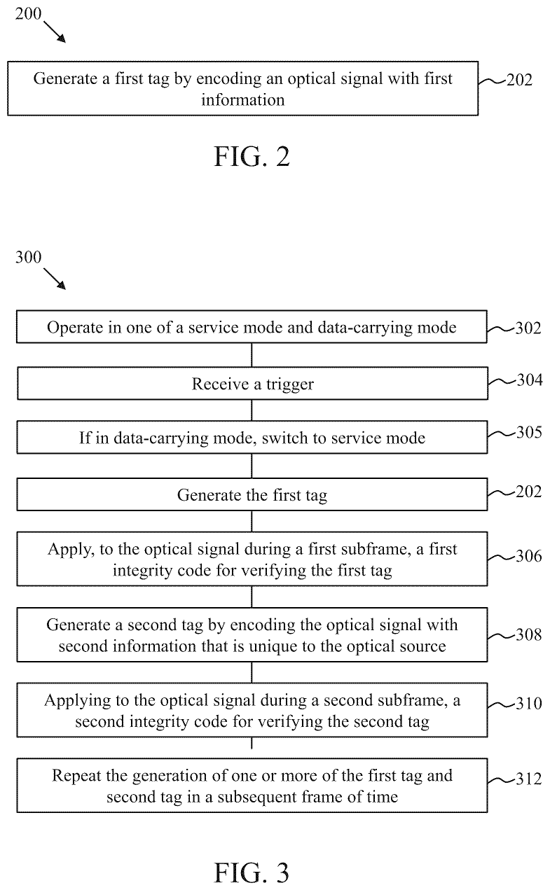

FIG. 2 is a flowchart of a method 200 of tagging an optical signal according to an embodiment. Reference is made to the WDM communication system 100 of FIG. 1 in the description of the method 200 and related embodiments.

The method 200 is implemented by an optical source 104 such as depicted by FIG. 1. The optical source controller 102 is configured to instruct the optical source 104 to implement the method 200 e.g., using an electronic control signal such as described above. The optical signal may be generated by the optical source 104 of the WDM communication system 100 when, for example during a service task, the WDM communication system 100 is configured to tag one or more optical signals.

The method 200 comprises, at block 202, generating a first tag by encoding the optical signal with first information. The optical source is in a set of optical sources of the WDM communication system 100. Each optical source 104 of the set of optical sources 104 is instructed to generate the first tag at a common time. The first information may be considered to be an identifier that is common to all of the optical signals of the set of optical sources 104a, 104b forming the aggregate signal.

In an implementation of the method 200, the set of optical sources 104 comprises a first optical source 104a and a second optical source 104b. A first optical signal is generated by the first optical source 104a and a second optical signal is generated by the second optical source 104b. The first optical source 104a and second optical source 104b is caused, by the optical source controller 102, to encode the first and second optical signals with the (same) first information at the common time. In other implementations of the method 200, more than two optical sources 104 may encode their respective optical signals with the first information at the common time.

The first information corresponds to the aggregate information, as described herein. Thus, the first information may be indicative of a parameter (such as location, identity or status of equipment) of the WDM communication system 100 where such a parameter may be useful for the service task. By deriving the first information from the first tag (in an optical signal or a WDM signal), information about the parameter may be determined to allow the service task to be performed. For example, connectivity information indicative of a proper (or improper) optical fiber connection between ports of host equipment and other equipment may be determined based on whether the expected (or unexpected) first information is derived from a detected optical signal or WDM signal.

The WDM communication system controller 116 may instruct one or more optical source controllers 102 to cause the set of optical sources 104 to generate the first tag at the common time. The optical source controller 102 may be instructed to control the operation of the set of optical sources 104 (where the set may comprise two or more optical sources 104 as described above). For example, an electronic control signal such as described above may be sent from the optical source controller 102 to the set of optical sources 104 of the host equipment 103. The electronic control signal is configured to modulate or cause the modulation of the optical output of the set of optical sources 104 such that the set of optical sources 104 generate the first tag at the common time.

The instructing of the one or more optical source controllers 102 may have the effect of synchronizing the timing of the encoding of the set of optical signals generated by the set of optical sources 104. In this manner, the resulting first tag (i.e., the encoded portion of the optical signal) in each one of the set of optical signals generated by the set of optical sources 104 has the same first information and is produced at the same time (i.e., within the same period of time) subject to an acceptable tolerance level for the synchronization.

From the perspective of a receiver of the set of optical signals (i.e., the multiplexed signal), the received signal comprising the first tag corresponds to the sum of the amplitudes of the optical signals in the set. Thus, multiplexing the set of optical signals has the effect of amplifying the individual optical signals into the resulting WDM signal (and hence the first tag is also amplified as compared to the first tag in the individual optical signals).

Since the first tag generated by the set of optical sources 104 is synchronized in time, the encoding of the first information in each of the set of optical signals has the same pattern in each of the first tags (e.g., each first tag may have the same amplitude modulation pattern such as modulation symbols to encode the first information) that is aligned at the common time. In other similar words, the first tag generated by the first optical source 104a starts and ends at the same time as (and is bitwise identical to) the first tag generated by the second optical source 104b (and similarly for any further first tags generated by the set of optical sources 104). The part of the optical signal that is to be multiplexed is therefore the same for all of the set of optical signals. However, since one or more of the optical signals may originate from different optical sources 104, a calendarized synchronization approach may be used to prevent scrambling (e.g., phase distortion) of the resulting multiplexed signal. The calendarized synchronization approach is described in more detail below.

Thus, the method 200 may extend the application of a tagging operation in the case of an optical fiber carrying an aggregate of multiple optical signals. The first tags of the set of optical signals may be aggregated (by multiplexing the set of optical signals) to form the WDM signal. The first tag may be useful for service tasks in certain locations where the aggregated/multiplexed WDM signal (rather than just a non-multiplexed optical signal) may be collected and analyzed.

The method 200 (and related embodiments described herein) may be used in the scenario where an optical signal is wavelength division multiplexed with other optical signals to form a WDM signal to be carried by an optical fiber. By tagging the optical signal in accordance with the method 200, information such as connectivity information may be determined from the WDM signal (or lack of such a signal). Further information may be derived from the tag such as concerning the identity, location, status, etc., of a component in the WDM communication system 100. The method 200 may enable such information to be determined at different physical locations in the WDM communication system, including where the WDM signal may be detected or where an optical signal (that has been demultiplexed from the WDM signal) may be detected. Such an approach may provide additional flexibility and control for service tasks. The method 200 may allow information to be extracted from the WDM signal (due to the synchronization of the transmission of tagging sequences (i.e., the first tags)) where such information may otherwise be scrambled due to the multiplexing. The functionality provided by the method 200 may facilitate a simple to use tool (which may be controlled by user equipment such as a smartphone) to assist an engineer with servicing complex optical fiber arrangements without having to rely solely on connection matrices printed on paper.

Some embodiments relating to the method 200 are now described.

In some embodiments, the set of optical sources 104 is configured to generate a set of optical signals. Each optical source 104 of the set of optical sources 104 may be configured to generate a different one of the set of optical signals. Each optical signal may be generated at a unique wavelength such that the set of optical signals can be multiplexed to form the WDM signal.

In some embodiments, the first information is common to the set of optical sources 104. The same first tag may be generated by each of the set of optical sources at the common time.

In some embodiments, the first information is indicative of a parameter of the WDM communication system 100. For example, the first information may be indicative of a parameter such as an identity of the set of optical sources 104 of the WDM communication system 100. The parameter may indicate a location of host equipment (e.g., the location of one or more nodes comprising the set of optical sources 104), an identifier of the host equipment (e.g., a customer identity, host identity, etc.), host equipment status (e.g., whether or not the host equipment is operational) or any other information about the WDM communication system 100. Deriving the parameter (e.g., the identity of the set of optical sources 104) from the first tag in a detected WDM signal or optical signal may assist with a service task e.g., by enabling a service engineer to work out which optical fiber is associated with which host equipment or other equipment, etc.

FIG. 3 is a flowchart of a method 300 of tagging an optical signal according to certain embodiments. Reference is made to the WDM communication system 100 of FIG. 1 in the description of the method 300 and related embodiments. The method 300 is implemented by the optical source 104, as in the method 200. The optical source controller 102 is configured to instruct the optical source 104 to implement the method 300 e.g., using an electronic control signal such as described above. In this case, the method 300 comprises the method 200. That is, the method 200 refers to the optical source 104 generating the first tag. The method 300 refers to further functionality of the optical source 104, as described below.

As will be described below in relation to certain embodiments, an optical signal may comprise a message comprising two parts (i.e., a bi-partite structure). In one part of the message, the set of optical signals is indicative of the aggregate information (via the first tag). In the second part of the message, “per-optical signal” information may be provided in a second tag where each optical signal has a unique tag indicative of the identity of the optical source 104 used to generate the optical signal.

Blocks of the method 300 are described below. Certain blocks may be omitted in some embodiments and the order of the blocks may be different in some embodiments.

In some embodiments, the method 300 comprises, at block 302, operating the WDM communication system 100 in one of a service mode and a data-carrying mode. A data plane of the WDM communication system 100 is used to carry data in the data-carrying mode. The data plane is unused in the service mode. The first tag (and any other tags as described herein) are generated in the service mode. In some embodiments, the tag(s) are generated in the data-carrying mode.

In some embodiments, the method 300 comprises, at block 304, receiving a trigger. The trigger may comprise an instruction received via the optical source controller 102. The trigger is configured to instruct the optical source 104 to generate the first tag at the common time. In some embodiments, in response to the trigger, the first tag is generated at block 202.

In some embodiments, the first tag is generated during a first subframe of a frame of time. Thus, each one of the set of optical sources 104 may generate the same first tag for each respective optical signal within the first subframe of the frame of time.

In some embodiments, if the WDM communication system 100 is in the data-carrying mode, the method 300 comprises, at block 305, causing the WDM communication system 100 to switch to the service mode. For example, a control instruction received from the apparatus 114 may cause the WDM communication system 100 to switch to the service mode e.g., such that the optical source 104 is instructed (via the optical source controller 102) to generate the first tag at the common time.

In some embodiments, the method 300 comprises, at block 306, applying, to the optical signal during the first subframe, a first integrity code for verifying the first tag. The first integrity code may facilitate error checking to verify the integrity of the first tag in case of an error in the WDM signal. An example of a first integrity code is a cyclic redundancy check (CRC) code.

In some embodiments, the method 300 comprises, at block 308, generating a second tag by encoding the optical signal with second information that is unique to the optical source 104. In some embodiments, the second tag is generated in response to a trigger, if such a trigger (received from or via the optical source controller 102) is used to cause the second tag (or first tag) to be generated. In some cases, the same trigger is used to trigger generation of both the first tag and second tag. In some cases, a first trigger may be dedicated to triggering generation of the first tag and a second trigger may be dedicated to triggering generation of the second tag. The second information may be derivable from the second tag in physical locations in the WDM communication system 100 where a single optical signal carrying the second tag can be detected (e.g., after the optical signal has been demultiplexed from a WDM signal). Since the second tag is unique to each optical signal, it may be challenging to descramble a multiplexed signal comprising two or more optical signals carrying their respective unique second tags.

In some embodiments, the second tag is generated during a second subframe of the frame. The first and second tags may be in any order. The order of the first and second tags may be the same for all of the set of optical signals for consistency. A frame and a subframe refers to is not limited to a particular meaning in terms of the length of time. The first and second subframes may or may not be of the same length (in terms of time) due to the different content of the first and second subframes.

In some embodiments, the method 300 comprises, at block 310, applying, to the optical signal during the second subframe, a second integrity code for verifying the second tag. The second integrity code may have the same function as the first integrity code but applied to the second tag. An example of a second integrity code is a CRC code.

In some embodiments, the method 300 comprises, at block 312, repeating the generation of one or more of the first tag and second tag in a subsequent frame of time. Thus, the first tag, second tag or first and second tags may be repeatedly generated in consecutive frames. In some cases, just the first tag or second tag may be repeatedly generated. For example, there may be service tasks where only the first tag is needed or only the second tag is needed. It may be helpful for the first tag or second tag to be repeatedly generated in subsequent frames in some service tasks.

In some embodiments, the second information is indicative of an identity of the optical source 104. For example, the second information may include an identifier of the optical source 104 that distinguishes the optical source 104 from the other optical sources 104 in the set, or provide any other relevant information such as location of the optical source 104.

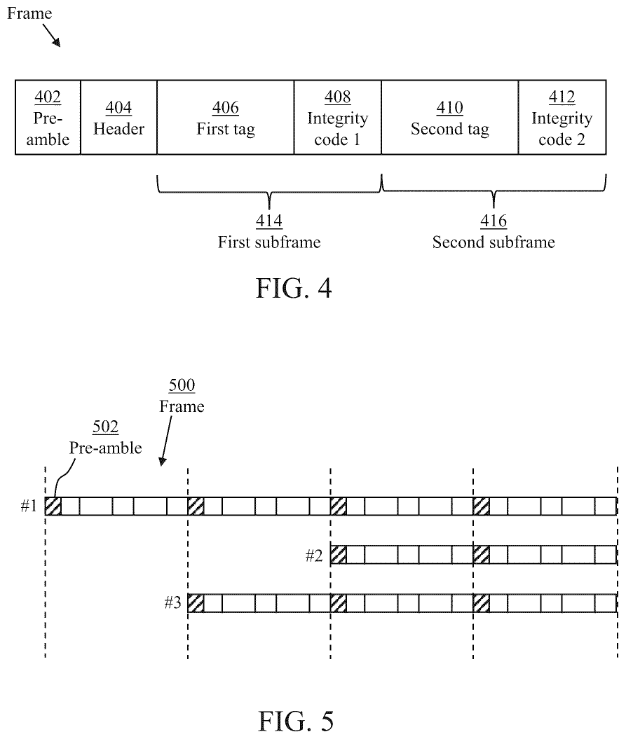

FIG. 4 is a schematic diagram illustrating a frame 400 of an optical signal according to an embodiment. The frame 400 corresponds to the frame of time described above and could be considered to comprise a message comprising two parts.

The frame 400 comprises content, in the following sequence: a pre-amble 402, header 404, first tag 406, first integrity code (integrity code 1) 408, second tag 410 and second integrity code (integrity code 2) 412. The first tag 406 and first integrity code 408 form a first subframe 414 of the period of time. The second tag 410 and second integrity code 412 form a second subframe 416 of the period of time. As already mentioned, the first and second subframes 414, 416 could be in any order. Although not depicted, in some cases, the pre-amble 402 and the header 404 could be considered to be part of the first subframe 414. Not all content in the frame 400 is needed to implement certain embodiments, as indicated by certain embodiments described herein.

The message (frame 400) is divided into two parts. In the first part of the message, the first tag 406 is indicative of the aggregate information (i.e., the first information). In the second part of the message, the second tag 410 is indicative of the “per-port” information (i.e., the second information) about the optical source 104 that generated the optical signal. Each subframe 414, 416 may have its own cyclic redundancy check (CRC) or other integrity coding.

The pre-amble 402 may allow for both frame and bit delineation.

The header 404 may indicate the length of the aggregate information in the first subframe 414 and the length of the per port information in the second subframe 416.

Depending on successfully verifying the integrity of one or more of the first tag and second tag, the apparatus 114 may determine one or more of the aggregate information and the per-port information, providing the WDM signal or optical signal is detected at a location that allows such information to be derived therefrom.

FIG. 5 is a schematic diagram illustrating frame alignment between optical signals of a set of optical signals according to an embodiment. In the diagram, each one of three optical sources (indicated by the labels #1, #2, #3) is configured to generate its associated optical signal comprising consecutive frames 500. Each frame 500 corresponds to the structure of the frame 400 of FIG. 4. The tagging operation by the optical sources is synchronized such that the frames 500 generated by each respective optical source are aligned in time. A calendarization technique is used to synchronize the start times of the frames 500 within the set of optical signals. The calendarization technique ensures the start time of a frame of one optical signal coincides with the start time of a frame of another optical signal (and the start time does not fall between the start and end times of a frame of another optical signal).

As depicted, an optical source repeatedly generates frames 500 comprising the same content in each successive frame. Each optical source is synchronized to use the same frame timing to ensure that the frames of the generated optical signal have the same start and end times as the frames of another optical signal generated by another optical source. The pre-amble 502 (corresponding to the pre-amble 402 of FIG. 4) of each frame 500 is shown to enable the start and end time of each frame 500 generated by the optical source to be easily identified. The start and end times of each frame 500 are indicated by the dashed lines in FIG. 5.

In some cases, the optical sources are synchronized such that they each start generating tagged optical signals at the same time. In some cases, one or more of the optical sources may start generating tagged optical signals at different times according to the calendarization technique. However, the frame structure is still aligned across the set of optical signals such that the start time of each tagged optical signal is the same. In this manner, the set of optical signals may be aggregated while ensuring that the first tag does not get scrambled in the aggregated WDM signal due to improper alignment of when the first tags are generated by each optical source.

An implementation of aligning the frames between individual optical signals of the set of optical signals using the calendarization technique is now described.

As depicted by FIG. 5, optical source #1 starts to generate its tagged optical signal comprising the content of the first frame 500 (i.e., within a first frame of time) generated by the optical source #1.

After the first frame of time has elapsed, optical source #3 starts to generate its tagged optical signal comprising the content of the frame 500 (within a second frame of time) generated by the optical source #3. The start time of the first frame 500 generated by optical source #3 is synchronized with the start time of the second frame 500 generated by optical source #1 (which has the same content as the first frame 500 generated by optical source #1).

After the second frame of time has elapsed, optical source #2 starts to generate its tagged optical signal comprising the content of the frame 500 generated by the optical source #3. The start time of the first frame 500 generated by the optical source #2 is synchronized with the start time of the third frame 500 generated by optical source #1 (which has the same content as the first and second frames 500 generated by optical source #1) and the start time of the second frame 500 generated by optical source #3 (which has the same content as the first frame 500 generated by optical source #3).

In this manner, the start and end time of each frame 500 generated by the optical sources #1, #2 and #3 is synchronized in time and each frame 500 is repeated at regular intervals based on the duration of the frame 500. Although not depicted, there may be a gap between frames, subframes, etc., if needed.

The frames 500 generated by the set of optical sources are therefore considered to be aligned such that the start and end within one frame 500 of one optical signal is the same as the start and end of the same frame 500 of another optical signal of the set of optical signals. Thus, the start and end time of the frames 500 are the same for each optical signal being generated by the set of optical sources 104. It follows that the first and second subframes (and other content including the tags) of each of the set of optical signals are aligned in the same manner across the set of optical signals.

The synchronization may ensure that all tagged optical signals forming the aggregate WDM signal are frame-aligned within permitted tolerances. This functionality may be achieved based on the calendarization technique.

In some examples, the synchronization acts so that the aggregate of the optical signals, which comprise the first tag (i.e., encoding the same first information in each of the optical signals generated by the set of optical sources 104) that is common to all ports (e.g., the set of optical sources 104) used to generate the set of optical signals, are transmitted at the same time. Thus, the transmitted first tags from all of the set of optical sources 104 is transmitted overlapping in time (with the first subframe comprising the first tag having the same start and end time for each first tag generated by the set of optical sources 104). Since the first information is common to all optical sources 104, the set of optical signals transmitted containing the same first tag in each optical signal is common to all the optical sources 104. As such, the commonly timed (i.e., overlapping) and identical symbols of the (same) first tag generated by the set of optical sources 104 are received with their intensities (i.e., power) added together at the detector 112 due to the overlap in time of each of the set of optical signals (each containing its own first tag with the same start time and end time for the first tag in each optical signal). This overlap in time (i.e., each optical source 104 turns on and off at the same time to produce modulation symbols corresponding to the first tag at the same time such that each optical source 104 produces the same first tag at the common time) amplifies the intensity of the WDM signal, aiding detection, providing the detector 112 has sufficiently spectral responsivity to detect the set of wavelengths generated by the set of optical sources 104.

The second information (i.e., encoded to form the second tags) transmitted is different for each optical source 104. As such, transmission of the second tags at the same time results in a detected transmission which is not easily readable, i.e., the different second tags are mixed together. The second tags are detectable within individual optical signals once the optical signals are separated, i.e., demultiplexed. The superposed second tags may be detected as an error during the second subframe (containing all the superposed second tags) in a WDM signal, e.g., by the second integrity check code. This may lead the second part of the message to be unusable because of the error. In the event that the second part of the message is unusable, this may be due to two or more second tags being detected by the detector 112 at the same time. In some scenarios, this may be expected (for example, when detecting the WDM signal). However, in some scenarios, the presence of two or more second tags may indicate an incorrect connection in the WDM communication system 100. For example, if a clean version of the second tag is expected (e.g., in a demultiplexed optical signal) but the second tag cannot be decoded from the detected optical signal(s), this may indicate to the service engineer that there is an incorrect connection between components in the WDM communication system 100.

When the set of optical signals are generated by a set of optical sources 104 hosted by two or more host equipment 103, the host equipment 103 are orchestrated (i.e., by the WDM communication system controller 116 via the control plane 118) to instruct the host equipment 103 on how to distribute the content in the frames. The WDM communication system controller 116 may ensure that the timing of the tags generated by the set of optical sources 104 occurs at the same (common) time, even if the set of optical sources 104 is hosted by two or more host equipment 103. In this manner, each tag generated by each optical source 104 is generated at the same time (e.g., within a frame of time) such that the start time of each frame is the same for each optical source 104. Thus, the transmission of tags may be synchronized across a set of optical sources 104. Controlling the timing of the transmission of the tags may be distributed among one or more host equipment 103 by implementing the calendarization technique. The one or more tags to include in each frame and the calendarization of the frames may be indicated by the control plane 118 (e.g., via a network management system (NMS), software defined network (SDN), etc.)

The WDM communication system controller 116 may provide the host equipment 103 of the WDM communication system 100 with one or more of a reference date and time (e.g., updating the date on a regular basis). The optical sources 104 may use the reference date and time to define when to start transmitting frames. The start time of a frame can only occur at the instants following the reference date and time according to “n” multiples of the frame duration. That is, the frame start time=reference date and time+n*frame duration.

For phase synchronization of tagged messages from different network nodes, packet synchronization systems (e.g., based on Precise Time Protocol (PTP)) may be used if available. PTP provides both frequency and phase and time synchronization. Otherwise, it may be sufficient if all transmitting nodes have the same phase error, e.g., originating from a common Global navigation satellite system (GNSS), e.g., global positioning system (GPS) synchronization reference or other global navigation service with an accurate time reference. In any case, the tolerable phase error is proportional to the transmission rate. For example, if the maximum tolerable error is estimated to be 1/10 of the duration of a bit, then the maximum tolerable phase error at a rate of 16 bits/s is 6.25 milliseconds.

In some embodiments, the apparatus 114 is configured to provide an indication of whether or not the phase errors across the set of tagged messages are tolerable so that appropriate action can be taken (e.g., by reducing the number of tagged messages that are transmitted at one time or by testing a different node or set of nodes comprising the set of optical sources).

If the set of optical sources 104 and apparatus 114 are configured to operate in a test mode (which may be part of the service mode) where each of the set of optical sources 104 transmit the same information corresponding to the first tag, all of the optical sources 104 may be triggered to generate a first tag comprising an identical square waveform at the same time. If the apparatus 114 is able to derive the square waveform with sufficient accuracy from the detected signal, then it is assumed that the phase error is tolerable.

If the receiver is not able to detect the square waveform with sufficient accuracy (e.g., due to phase error exceeding an acceptable level), one or more of the transmitting optical sources 104 can be disabled until the accuracy is sufficient. In some cases, all but one of the optical sources 104 may be deactivated. In some cases, one or more optical sources 104 may be deactivated one at a time (i.e., gradually deactivated) until a condition is reached where the apparatus 114 can derive the square waveform with sufficient accuracy. At this point, only the remaining transmitters are activated.

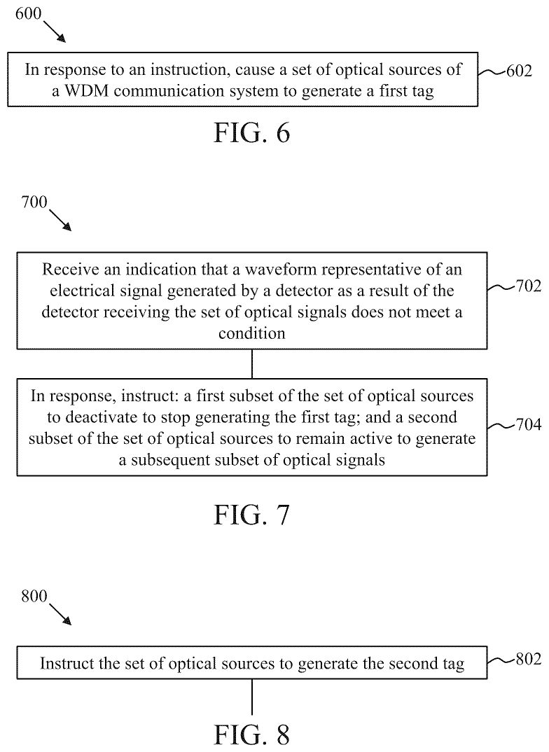

FIG. 6 is a flowchart of a method 600 of controlling a WDM communication system 100 according to an embodiment. Reference may be made to the features described in relation to FIGS. 1-5 in the description of the method 600 and its related embodiments.

The method 600 is implemented by a WDM communication system controller 116 such as depicted by FIG. 1. As noted above, the WDM communication system controller 116 is configured to control the optical source controller 102 (e.g., to facilitate implementation of the methods 200, 300 and related embodiments).

The method 600 comprises, at block 602, in response to an instruction, causing a set of optical sources 104 of the WDM communication system 100 to generate a first tag 406. The first tag 406 is generated by encoding an optical signal generated by the optical source 104 with first information. Each of the set of optical sources 104 is caused to generate the first tag at a common time.

In some embodiments, the instruction may comprise a control instruction provided by the apparatus 114 to the WDM communication system controller 116 via the communication link 120. The instruction may cause the WDM communication system controller 116 to in turn cause (e.g., instruct or otherwise trigger) the set of optical sources 104 to generate the first tag 406. That is, each of the set of optical sources 104 are caused to generate the same first tag 406 at the common time.

The set of optical sources 104 are controlled by the optical source controller 102. The optical source controller 102 may receive an instruction (or trigger) from the WDM communication system controller 116 (e.g., in response to the WDM communication system controller 116 itself receiving an instruction from the apparatus 114). The received instruction or trigger causes the optical source controller 102 to in turn instruct the set of optical sources 104 to generate the first tag 406 at the common time.

The WDM communication system controller 116 may comprise a processor and a memory (not shown but see below) storing instructions readable and executable by the processor to cause the set of optical sources 104 to generate the first tag 406.

The WDM communication system controller 116 may facilitate the synchronization of the set of optical sources 104. The WDM communication system controller 116 may implement the calendarization technique to facilitate the synchronization of the frames 400 across multiple nodes that may host the set of optical sources 104.

FIG. 7 is a flowchart of a method 700 of controlling a WDM communication system 100 according to certain embodiments. Reference may be made to the features described in relation to FIGS. 1-6 in the description of the method 700 and its related embodiments. The method 700 is implemented by the WDM communication system controller 116, as in the method 600. In this case, the method 700 comprises the method 600. That is, the method 600 refers to the WDM communication system controller 116 controlling the optical source controller 102. The method 700 refers to further functionality of the WDM communication system controller 116, as described below.

In some embodiments, the method 700 comprises, at block 702, receiving an indication that a waveform (e.g., the square waveform or another appropriate waveform) representative of an electrical signal generated by a detector 112 as a result of the detector 112 receiving the set of optical signals does not meet a condition indicative of the first tag 406 being generated by each of the set of optical sources 104 with a tolerable relative phase error. Phase error refers to the timing delay between the arrival of each of the first tags 406 (of the set of optical signals) at the detector 112. If all first tags arrive at exactly the same time, the phase error is zero. However, if one of more of the first tags 406 arrive at slightly different times to each other, the first tags 406 may be misaligned with respect to each other such that the symbols of each first tag 406 do not align in time with the corresponding symbols of other first tags 406. In other words, there may be a drift between symbols of each of the first tags 406, which could lead to difficulty in decoding the part of the waveform that is representative of the first tag 406 to extract the first information. The tolerable phase error may refer to an acceptable symbol drift between the first tags 406 generated by the set of optical sources 104 such that the first information can be extracted from the detected waveform without error.

In response to block 702, the method 700 comprises, at block 704, instructing a first subset (e.g., one or more optical sources) of the set of optical sources 104 to deactivate to stop generating the first tag 406. Deactivating one or more of the optical sources 104 may reduce the delay (and hence reduce phase error) between two or more of the first tags 406. If a deactivated optical source 104 is associated with a first tag 406 that has a relative delay with respect to another first tag 406 generated by another optical source 104, the deactivated optical source 104 no longer contributes to the overall phase error associated with the still activated optical source(s) 104, thereby reducing the phase error. Thus, if the phase error between the first tags is too large, the resulting signal is affected by interference and is unable to be decoded correctly. Disabling one or more of the optical sources 104 to reduce the number of first tags reduces the likelihood of this happening. At the limit, if only one optical source 104 remained to produce the first tag 104, there would be no interference.

Block 704 further comprises instructing a second subset (e.g., one or more optical sources) of the set of optical sources 104 to remain active to generate a subsequent subset of optical signals. Each of the subset of optical signals comprises the first tag 406 such that a subsequent waveform representative of an electrical signal generated by the detector 112 as a result of the detector 112 receiving the subset of optical signals meets the condition.

FIG. 8 is a flowchart of a method 800 of controlling a WDM communication system 100 according to certain embodiments. Reference may be made to the features described in relation to FIGS. 1-7 in the description of the method 800 and its related embodiments. The method 800 is implemented by the WDM communication system controller 116. In this case, the method 800 comprises the method 600. That is, the method 600 refers to the WDM communication system controller 116 controlling the optical source controller 102. The method 800 refers to further functionality of the WDM communication system controller 116, as described below.

In some embodiments, the first tag is generated in a first subframe of a frame of time.

In some embodiments, the method 800 comprises, at block 802, instructing the set of optical sources 104 to generate the second tag 410 e.g., in a second subframe of the frame of time. The second tag is generated by each optical source 104 by encoding the optical signal generated by the optical source with second information that is unique to the optical source.

The first tag 406 has a start time and end time. The start time and end time of the first tag 406 is the same for each of the first tags 406 generated by the set of optical sources 104.

The second tag 410 has a start time and end time. The start time and end time of the second tag 410 is the same for each of the second tags 410 generated by the set of optical sources 104.

Each of the set of optical sources 104 is instructed, via the optical source controller 102, to generate one or both of the first tag 406 and second tag 410. That is, the WDM communication system controller 116 instructs each of the set of optical sources 104 (e.g., via the optical source controller 102) to generate one or both of the first tag 406 and second tag 410.

In some embodiments, each of the set of optical sources 104 is instructed, via the optical source controller 102, to repeat generation of one or more of the first tag 406 and second tag 410 in a subsequent frame of time.

In some embodiments, a start time of the frame for each of the set of optical sources 104 is equal to a reference time plus a multiple of a duration of the frame. In some embodiments, a reference date is included with the reference time.

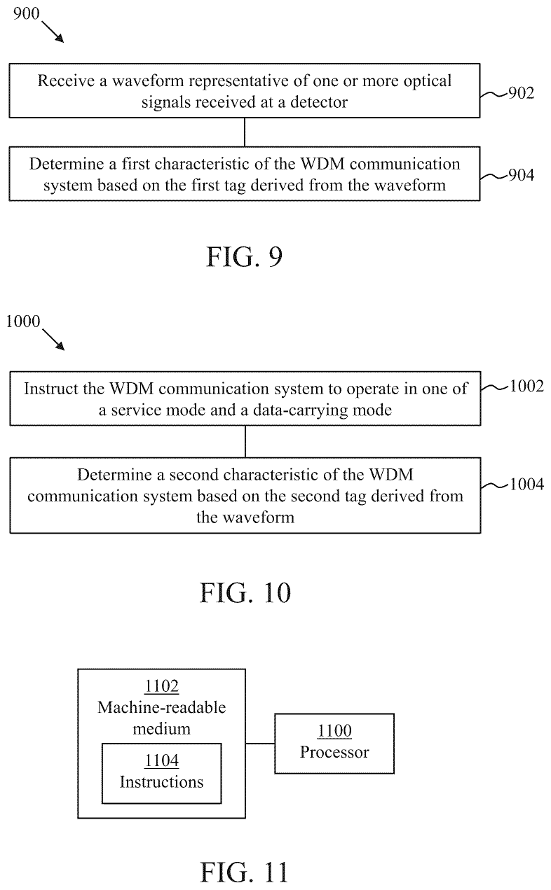

FIG. 9 is a flowchart of a method 900 of evaluating a WDM communication system 100 according to an embodiment. Reference may be made to the features described in relation to FIGS. 1-8 in the description of the method 900 and its related embodiments.

The method 900, which is computer-implemented, is implemented by an apparatus 114 such as depicted by FIG. 1. As noted above, the apparatus 114 is configured to process the detected signal to extract the information therefrom. The apparatus 114 may also be configured to instruct the WDM communication system controller 116 to instruct the optical source controller 102 accordingly.

The method 900 comprises, at block 902, receiving a waveform (e.g., an electrical signal representing the waveform) representative of one or more optical signals received at a detector 112. The waveform is indicative of a first tag 406 generated by one or more optical sources 104 of the set of optical sources 104 of the WDM communication system 100. For example, a set of (modulation) symbols representative of the first tag 406 may be derived from the waveform (e.g., by demodulation). The first tag 406 is generated by encoding the optical signal generated by the optical source 104 with first information. Each of the set of optical sources 104 is instructed (e.g., by the optical source controller 102) to generate the first tag at a common time.

The method 900 further comprises, at block 904, determining a first characteristic of the WDM communication system 100 based on the first tag 406 derived from the waveform. The waveform may be processed by the apparatus 114 in order to extract the first tag 406, and hence derive the first characteristic based on the first tag 406. For example, the first tag 406 may be decoded in order to extract the first information. The first information may be indicative of the first characteristic, which is described below. For example, the first information may indicate, for example via a predetermined code or other indicator known to the apparatus 114, information such as an identity of the set of optical sources 104.

The apparatus 114 may comprise a processor and a memory (not shown but see below) storing instructions readable and executable by the processor to implement the method 800 and related embodiments.

In some embodiments, the first characteristic is indicative of a connection quality of an optical fiber of the WDM communication system 100 that is configured to carry the set of optical signals.

In some embodiments, the first characteristic is indicative of an operating status of one or more of the set of the optical sources 104.

In some embodiments, the first characteristic is indicative of an identity of one or more of the set of optical sources 104. There may be multiple nodes comprising one or more of the set of optical sources 104. The identity may indicate which node hosts a particular optical source 104 (associated with the detected optical signal or WDM signal).

In some embodiments, the first characteristic is indicative of a location of one or more of the set of optical sources 104.

In some embodiments, the first characteristic is indicative of another component of the WDM communication system 100. Other components may include passive components (such as WDM multiplexers, demultiplexers, filters, etc.) of the WDM communication system 100. The first characteristic may be indicative of the connection quality, operating status, identity or location of such a component. The other component may include a peer component such as an optical source belonging to a passive component of the WDM communication system 100.

FIG. 10 is a flowchart of a method 1000 of evaluating a WDM communication system 100 according to certain embodiments. Reference may be made to the features described in relation to FIGS. 1-9 in the description of the method 1000 and its related embodiments. The method 1000 is implemented by the apparatus 114, as in the method 900. In this case, the method 1000 comprises the method 900. That is, the method 900 refers to the apparatus 114 determining a first characteristic of the WDM communication system based on the first tag 406. The method 1000 refers to further functionality of the apparatus 114, as described below.

Blocks of the method 1000 are described below. Certain blocks may be omitted in some embodiments and the order of the blocks may be different in some embodiments.

In some embodiments, the method 1000 comprises, at block 1002, instructing the WDM communication system 100 to operate in one of a service mode and a data-carrying mode. A data plane of the WDM communication system is used to carry data in the data-carrying mode. The data plane is unused in the service mode. The first tag 406 is generated in the service mode. Similarly, the second tag 410 may be generated in the service mode.

In some embodiments, the waveform (e.g., an electrical signal representing the waveform) is further indicative of a second tag 410 generated by one of the optical sources 104. For example, a set of (modulation) symbols representative of the second tag 410 may be derived from the waveform (e.g., by demodulation). The second tag 410 is generated by the optical source 104 by encoding the optical signal generated by the optical source 104 with second information that is unique to the optical source 104. The method 1000 further comprises, at block 1004, determining a second characteristic of the WDM communication system 100 based on second tag 410 derived from the waveform. The waveform may be processed by the apparatus 114 in order to extract the second tag 410, and hence derive the second characteristic based on the second tag 410. For example, the second tag 410 may be decoded in order to extract the second information. The second information may be indicative of the second characteristic, which is described below. For example, the second information may indicate, for example via a predetermined code or other indicator known to apparatus 114, information such as an identity of an optical source 104 that generated the second tag 410.

In some embodiments, the second characteristic is indicative of a connection quality of an optical fiber of the WDM communication system 100 that is configured to carry the optical signal after being demultiplexed.

In some embodiments, the second characteristic is indicative of an operating status of the optical source 104 configured to generate the optical signal. In this case, the optical signal is the optical signal after being demultiplexed.

In some embodiments, the second characteristic is indicative of an identity of the optical source 104 configured to generate the optical signal. In this case, the optical signal is the optical signal after being demultiplexed. Hence, the identity refers to the identity of an individual optical source 104.

In some embodiments, the second characteristic is indicative of a location of the optical sources 104 configured to generate the optical signal. In this case, the optical signal is the optical signal after being demultiplexed.

In some embodiments, the second characteristic is indicative of an identity of a customer (e.g., associated with the optical source 104). In this case, the optical signal is the optical signal after being demultiplexed.

In some embodiments, the second characteristic is indicative of an identity of a destination (e.g., a node) for receiving the optical signal. In this case, the optical signal is the optical signal after being demultiplexed.

FIG. 11 is a schematic diagram illustrating a processor 1100 and a machine-readable medium 1102 (e.g., a memory) for implementing certain embodiments, including any of the methods and related embodiments described herein. The machine-readable medium 1102 stores instructions 1104 which, when executed by the processor 1100, instruct the processor 1100 to implement such methods and related embodiments. A machine-readable medium may include a non-transitory machine-readable medium, where the term “non-transitory” does not encompass transitory propagating signals. Otherwise, any appropriate memory may be used to store the instructions 1104.

Any element or functionality of a described embodiment may be combined with or replace a corresponding element or functionality of another described embodiment.

A processor (which includes one or more processors) may include a central processing node (CPU), application specific integrated circuit (ASIC), field programmable gate array (FPGA) or the like. A memory may include one or several types of memory suitable for the processor, such as read-only memory (ROM), random-access memory, cache memory, flash memory devices, optical storage devices, solid state disk, hard disk drive, etc.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

The above-described embodiments are intended to be examples only. Alterations, modifications and variations may be effected to the particular embodiments by those of skill in the art without departing from the scope of the description, which is defined solely by the appended claims.

1. A method of tagging an optical signal generated by an optical source of a wavelength division multiplexing, WDM, communication system, the method comprising:
generating a first tag by encoding the optical signal with first information, wherein the optical source is in a set of optical sources of the WDM communication system, wherein each of the set of optical sources is instructed to generate the first tag at a common time.

2. The method of claim 1, wherein the set of optical sources is configured to generate a set of optical signals, wherein each optical source of the set is configured to generate a different one of the set of optical signals.

3. The method of claim 1, wherein the first information is common to the set of optical sources, and wherein the same first tag is generated by each of the set of optical sources at the common time.

4. The method of claim 1, wherein the first information is indicative of an identity of the set of optical sources.

5. The method of claim 1, comprising:
generating a second tag by encoding the optical signal with second information that is unique to the optical source.

6. The method of claim 5, wherein the second information is indicative of an identity of the optical source.

7. The method of claim 1, comprising operating the WDM communication system in one of a service mode and a data-carrying mode, wherein a data plane of the WDM communication system is used to carry data in the data-carrying mode, wherein the data plane is unused in the service mode, and wherein the first tag is generated in the service mode.

8. The method of claim 1, comprising receiving a trigger, wherein the trigger is configured to instruct the optical source to generate the first tag at the common time.

9. A method of controlling a wavelength division multiplexing, WDM, communication system, the method comprising:
in response to an instruction, causing a set of optical sources of the WDM communication system to generate a first tag, wherein the first tag is generated by encoding an optical signal generated by the optical source with first information, wherein each of the set of optical sources is instructed to generate the first tag at a common time.

10. The method of claim 9, comprising:
receiving an indication that a waveform representative of an electrical signal generated by a detector as a result of the detector receiving the set of optical signals does not meet a condition indicative of the first tag being generated by each of the set of optical sources with a tolerable relative phase error; and
in response, instructing;
a first subset of the set of optical sources to deactivate to stop generating the first tag; and
a second subset of the set of optical sources to remain active to generate a subsequent subset of optical signals, wherein each of the subset of optical signals comprises the first tag such that a subsequent waveform of an electrical signal generated by the detector as a result of the detector receiving the subset of optical signals meets the condition.

11. The method of claim 9, comprising instructing the set of optical sources to generate a second tag, wherein the second tag is generated by each optical source by encoding the optical signal generated by the optical source with second information that is unique to the optical source.

12. A computer-implemented method of evaluating a wavelength division multiplexing, WDM, communication system, the method comprising:
receiving a waveform representative of one or more optical signals received at a detector, wherein the waveform is indicative of a first tag generated by one or more optical sources of a set of optical sources of the WDM communication system, wherein the first tag is generated by encoding the optical signal generated by the optical source with first information, wherein each of the set of optical sources is instructed to generate the first tag at a common time; and
determining a first characteristic of the WDM communication system based on the first tag derived from the waveform.

13. The computer-implemented method of claim 12, wherein the first characteristic is indicative of one or more of:
a connection quality of an optical fiber of the WDM communication system that is configured to carry the set of optical signals;
an operating status of one or more of the set of the optical sources;
an identity of one or more of the set of optical sources;
a location of one or more of the set of optical sources; and
another component of the WDM communication system.

14. The computer-implemented method of claim 12, comprising instructing the WDM communication system to operate in one of a service mode and a data-carrying mode, wherein a data plane of the WDM communication system is used to carry data in the data-carrying mode, wherein the data plane is unused in the service mode, and wherein the first tag is generated in the service mode.

15. The computer-implemented method of claim 12, wherein the waveform is further representative of a second tag generated by one of the optical sources, wherein the second tag is generated by the optical source by encoding the optical signal generated by the optical source with second information that is unique to the optical source, and wherein the method comprises:
determining a second characteristic of the WDM communication system based on the second tag derived from the waveform.

16. The computer-implemented method of claim 15, wherein the second characteristic is indicative of one or more of:
a connection quality of an optical fiber of the WDM communication system that is configured to carry the optical signal;
an operating status of the optical source configured to generate the optical signal;
an identity of the optical source configured to generate the optical signal;
a location of the optical sources configured to generate the optical signal;
an identity of a customer; and
an identity of a destination for receiving the optical signal.

17. An optical source controller for controlling tagging of an optical signal generated by an optical source of a wavelength division multiplexing, WDM, communication system. wherein the optical source controller is configured to instruct the optical source to implement the method of claim 1.

18. A wavelength division multiplexing, WDM, communication system controller for controlling a WDM communication system, wherein the WDM communication system controller is configured to instruct the WDM communication system to implement the method of claim 9.

19. Apparatus for evaluating a wavelength division multiplexing, WDM, communication system, wherein the apparatus is configured to implement the computer-implemented method of claim 12.

20. A wavelength division multiplexing, WDM, communication system comprising:
a set of optical sources; and
an optical source controller configured to control tagging of optical signals generated by the optical sources, wherein the optical source controller is configured to instruct the optical source to generate a first tag by encoding the optical signal with first information, wherein each of the set of optical sources is instructed to generate the first tag at a common time.

21. (canceled)
